(19) United States
(12) Patent Application Publication
(10) Pub. No.: US 2024/0429732 A1
(43) Pub. Date: Dec. 26, 2024

(54) RELAY STATUS MONITOR CIRCUIT

(71) Applicant: TEXAS INSTRUMENTS INCORPORATED, Dallas, TX (US)

(72) Inventors: Kelvin Le, Dallas, TX (US); Riccardo Ruffo, Muenchen (DE); David Stout, Chico, TX (US); FNU Nitish, Dallas, TX (US)

(21) Appl. No.: 18/617,856

(22) Filed: Mar. 27, 2024

Related U.S. Application Data
(60) Provisional application No. 63/522,617, filed on Jun. 22, 2023.

(51) Int. Cl. H02J 7/04; B60L 53/60

(52) U.S. Cl. CPC H02J 7/04; B60L 53/60

(57) ABSTRACT

A battery charger includes a relay having a first terminal and a second terminal. A capacitor has a first terminal and a second terminal. The first terminal is coupled to the second terminal of the relay. A clamp circuit is coupled to the second terminal of the capacitor. A reference voltage circuit has an output terminal. A comparator has a first comparator input terminal coupled to the second terminal of the capacitor and has a second comparator input terminal coupled to the output terminal of the reference voltage circuit.

### CROSS-REFERENCE TO RELATED APPLICATIONS

This application claims priority to U.S. Provisional Application No. 63/522,617, filed Jun. 22, 2023, which is hereby incorporated by reference.

### BACKGROUND

An electric vehicle (EV) charger includes a relay for each power line from the grid to the on-board charger (OBC) of the EV. When the charger's cable is not connected to the EV, for safety reasons, the relays are open. After the EV charger cable is connected to the EV, the relays close following the completion of handshake signaling thereby allowing current to flow to the OBC to charge the EV's batteries. At the end of the charging cycle, the relays open thereby allowing the charger's cable to be disconnected from the EV without live voltage present at the end of the cable.

### SUMMARY

In one example, a battery charger includes a relay having a first terminal and a second terminal. A capacitor has a first terminal and a second terminal. The first terminal is coupled to the second terminal of the relay. A clamp circuit is coupled to the second terminal of the capacitor. A reference voltage circuit has an output terminal. A comparator has a first comparator input terminal coupled to the second terminal of the capacitor and has a second comparator input terminal coupled to the output terminal of the reference voltage circuit.

In another example, a circuit includes a capacitor having a first terminal and a second terminal. A clamp circuit is coupled to the second terminal of the capacitor. A reference voltage circuit has an output terminal. A comparator has a first input terminal coupled to the second terminal of the capacitor and has a second input terminal coupled to the output terminal of the reference voltage circuit. The comparator has an output terminal. A peak detector is coupled to the output terminal of the comparator.

In yet another example, a battery charger includes a relay having a first terminal, a second terminal, and a control terminal. A controller has an output terminal and an input terminal. The output terminal is coupled to the control terminal. A relay status monitor circuit has a first terminal and a second terminal. The first terminal of the relay status monitor circuit is coupled to the second terminal of the relay. The second terminal of the relay status monitor circuit is coupled to the input terminal of the controller. The relay status monitor circuit includes a capacitor coupled to the first terminal of the relay status monitor circuit. The relay status monitor circuit is configured to determine a state of the relay and generate a signal at the second terminal of the relay status monitor circuit indicative of the state.

### BRIEF DESCRIPTION OF THE DRAWINGS

FIG. 1 is a block diagram of an alternating current (AC) charger for use in charging the batteries of a vehicle, the AC charger including a relay status monitor circuit, in an example.

FIG. 2 is a block diagram of a direct current (DC) charger for use in charging the batteries of a vehicle, the DC charger including a relay status monitor circuit, in an example.

FIG. 3 is a schematic diagram of a relay status monitor circuit for use in a single-phase AC charger, in an example.

FIG. 4 are waveforms of signals generated by the relay status monitor circuit of FIG. 3, in an example.

FIG. 5 is a schematic diagram of another example of a relay status monitor circuit for use in a single-phase AC charger.

FIGS. 6a and 6b are example waveforms of signals generated by the relay status monitor circuit of FIG. 5.

FIG. 7 is a block diagram of the relay status monitor circuit for use in a multi-phase AC charger, in an example.

FIG. 8 is a schematic diagram of a relay status monitor circuit of FIG. 7 including examples of clamp circuits.

FIGS. 9, 10, and 11 are example waveforms illustrating the operation of the relay status monitor circuit of FIG. 8.

FIG. 12 is a block diagram of a relay status monitor circuit that includes a pulse generator, in an example.

FIG. 13 is a block diagram of a three-phase AC charger whose relay status monitor circuit includes a pulse generator, in an example.

FIGS. 14A, 14B, 14C are example waveforms illustrating the operation of the relay status monitor circuit of FIG. 13.

FIG. 15 is a schematic diagram of a DC charger including a relay status monitor circuit, in an example.

FIGS. 16 and 17 are example waveforms illustrating the operation of the relay status monitor circuit of FIG. 15.

### DETAILED DESCRIPTION

The same reference numbers or other reference designators are used in the drawings to designate the same or similar (either by function and/or structure) features.

As a relay is closing, one relay contact draws increasingly closer to the other relay contact until the contacts touch. Due to the relatively high voltage of the grid (e.g., 210 VAC), it is possible for arcing to occur between the contacts resulting in the contacts being welded together. At the end of the charging cycle, unfortunately a welded relay may not open. The examples described herein are directed to a relay status monitor circuit that detects whether a relay is open or closed and generates a corresponding relay status signal. A monitor and control circuit generates control signals to the relays to cause the relays to open or close. The monitor and control circuit receives the relay status signal from the relay status monitor circuit and can take corrective action based on whether the relay should be open or closed and whether, based on the relay status signal, the relay actually is open or closed.

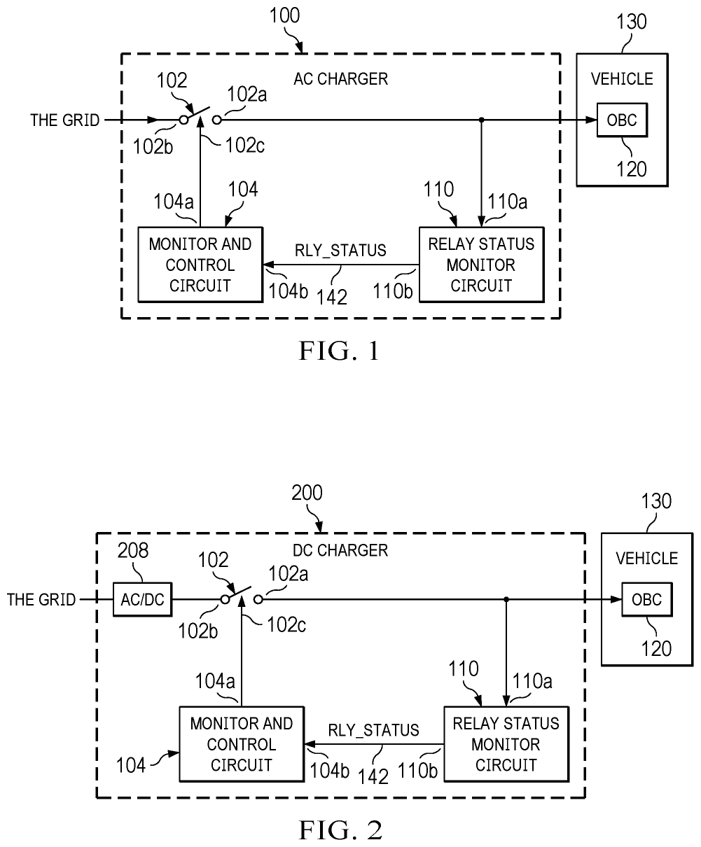

The disclosed relay status monitor circuit can be included within an alternating current (AC) charger or a direct current (DC) charger. FIG. 1 is a block diagram of an AC charger 100 coupled to an OBC 120 of a vehicle 130 (e.g., an EV). AC charger 100 includes a relay 102 having terminals 102a and 102b. Terminal 102a is coupled to the grid (e.g., AC voltage), and terminal 102b is coupled to the OBC 120. Although only one relay 102 is shown in FIG. 1, multiple relays 102 may be present-one relay for each power conductor coupling the grid to the OBC 120. The grid may be a four-conductor voltage system including a conductor for each phase of a three-phase voltage system and a neutral conductor. The three phases may be phase-shifted from each other by 120 degrees. In some applications, AC charger 100 charges the batteries of the vehicle 130 using a single phase of the grid. In such applications, one relay 102 couples one phase to OBC 120, and another relay 102 couples the neutral to OBC 120. In other applications, AC charger 100 couples all three phases to OBC 120. In such applications, four relays 102 are present—one relay 102 for each conductor of the three phases and a fourth relay 102 for the neutral.

AC charger 100 also includes a monitor and control circuit 104 and a relay status circuit 110. Monitor and control circuit 104 includes an output 104a that is coupled to a control terminal 102c of relay 102. In some examples, monitor and control circuit 104 may include a processor executing machine instructions stored in memory. In other examples, monitor and control circuit 104 may be implemented as a discrete circuit, e.g., a combination of logic gates, registers, flip-flops, etc. Monitor and control circuit 104 can cause relay 102 to be open or closed by way of a control signal to the relay's control terminal 102c. Monitor and control circuit 104 also has an input terminal 104b.

Relay status monitor circuit 110 includes terminals 110a and 110b. Terminal 110a is coupled to terminal 102a of relay 102. Terminal 110b is coupled to input terminal 104b of monitor and control circuit 104. Relay status monitor circuit 110 determines whether relay 102 is open or closed and provides a status signal 142 (labeled RLY_STATUS signal 142) to monitor and control circuit 104. In some example, the RLY_STATUS signal 142 may be logic high to indicate to monitor and control circuit that relay 102 is closed and logic low to indicate that relay 102 is open. The polarity of the RLY_STATUS signal 142 may be the opposite as well-logic high indicates the relay is open and logic low indicates the relay is closed.

FIG. 2 is a block diagram of a DC charger 200, similar to that of the AC charger 100 of FIG. 1. DC charger 200 includes relay 102, monitor and control circuit 104, and relay status monitor circuit 110, and an AC/DC converter 208. AC/DC converter 208 converts AC voltage from the grid to a DC voltage to be provided through relay 102 to the vehicle's OBC 120.

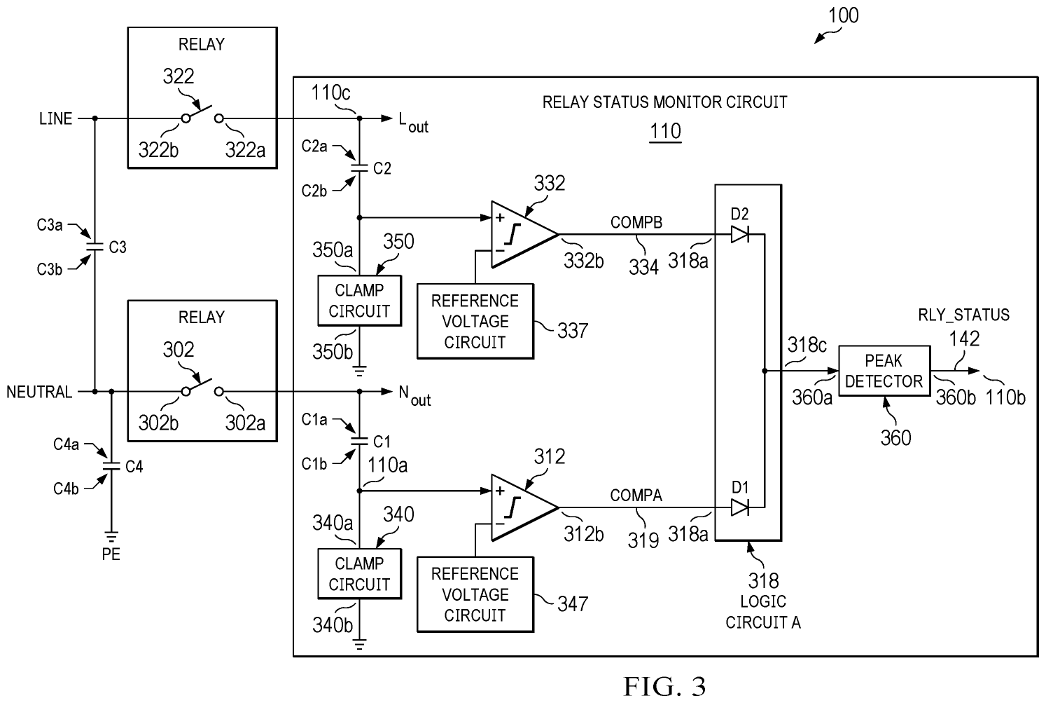

FIG. 3 is a schematic diagram of a relay status monitor circuit 110 for use in a single-phase AC charger (e.g., AC charger 100). The single-phase AC charger of FIG. 3 includes capacitors C3 and C4 and relays 302 and 322, which are coupled to relay status monitor circuit 110. Relay 302 includes terminals 302a and 302b, and relay 322 includes terminals 322a and 322b. In this example, a line voltage (LINE), which is one of the phases of a multi (e.g., three) phase voltage system, and a neutral are coupled to terminals 302b and 322b of relays 302 and 322, respectively. A terminal of capacitor C3 is coupled to terminal 322b of relay 322, and the other terminal of capacitor C3 is coupled to terminal 302b of relay 302. A terminal of capacitor C4 is coupled to terminal 302b of relay 302 and to ground (PE). Terminals 302a and 322a are coupled to OBC 120 (FIG. 1). In addition to terminals 110a and 110b, in this example relay status monitor circuit 110 includes a terminal 110c. Terminal 110a is coupled to terminal 302a of relay 302, and terminal 110c is coupled to terminal 322a of relay 322.

In FIG. 3, relay status monitor circuit 110 includes capacitors C1 and C2, clamp circuits 340 and 350, comparators 312 and 332, reference voltage circuits 337 and 347, a logic circuit A 318, and a peak detector 360. Capacitor C1 has terminals C1a and C1b. Clamp circuit 340 has terminals 340a and 340b. Comparator 312 has a positive input terminal, a negative input terminal, and an output terminal 312b. Capacitor C2 has terminals C2a and C2b. Clamp circuit 350 has terminals 350a and 350b. Comparator 332 has positive and negative input terminals and an output 332b. A reference voltage is generated at the output of each respective reference voltage circuit 337 and 347. The output of reference voltage circuit 337 is coupled to the negative terminal of comparator 332, and the output of reference voltage circuit 347 is coupled to the negative terminal of comparator 312. Logic circuit A 318 has terminals 318a, 318b, and 318c. Peak detector 360 has an input terminal 360a and an output terminal 360b.

Terminal C1a of capacitor C1 is coupled to terminal 110a of relay status monitor circuit 110 and, accordingly, to terminal 302a of relay 302. Terminal C1b is coupled to terminal 340a of clamp circuit 340 and to the positive terminal of comparator 312. Terminal 340b of clamp circuit 340 is coupled to a ground terminal. Terminal C2a of capacitor C2 is coupled to terminal 110c of relay status monitor circuit 110 and, accordingly, to terminal 322a of relay 322. Terminal C2b is coupled to terminal 350a of clamp circuit 350 and to the positive terminal of comparator 332. Terminal 350b of clamp circuit 350 is coupled to the ground terminal.

Logic circuit 318 A includes diodes D1 and D2. The anodes of diodes D1 and D2 are coupled to terminals 318a and 318b of logic circuit A. Output terminal 312b of comparator 312 is coupled to terminal 318a of logic circuit A 318 and, accordingly, to the anode of diode D1. Similarly, output terminal 332b of comparator 332 is coupled to terminal 318b of logic circuit A 318 and to the anode of diode D2. The output signal from comparator 312 is output signal COMPA 319, and the output signal form comparator 332 is output signal COMPB 339. The cathodes of diodes D1 and D2 are coupled together and to terminal 318c of logic circuit A 318. Terminal 316 of logic circuit 318 A is coupled to the input terminal 360a of peak detector 360. The output terminal of peak detector 360 is coupled to terminal 110b of relay status monitor circuit.

If relays 302 and 322 are open, the voltage on terminals C1b and C2b of capacitors C1 and C2 are pulled to ground through the corresponding clamp circuits 340, 350. Comparators 312 and 332 respond to a 0V at their positive terminals 312a and 332b by forcing their respective output signals COMPA 319 and COMPB 339 to logic 0. Diodes D1 and D2 logically OR together output signals COMPA 319 and COMPB 339. The output signal of peak detector 360 is the RLY_STATUS signal 142. With both relays open, both output signals COMPA 319 and COMPB 339 are logic 0 and, accordingly, the input signal to peak detector 360 is logic 0 and peak detector 360 generates the RLY_STATUS signal 142 to be logic 0 indicating that both relays are open.

If relay 322 is closed, e.g., welded closed or controlled to be closed by monitor and control circuit 104, comparator 332 trips logic high during each positive half-cycle of the line voltage. As the line voltage through relay 322 increases sinusoidally from 0V towards its peak during each positive half-cycle, the voltage on terminal C2b of capacitor also increases sinusoidally. When the voltage on terminal 332a of comparator 332 exceeds the reference voltage provided to the comparator, comparator 332 forces output signal COMPB 339 to a logic high state. For example, if the reference voltage is 500 mV, COMPB 339 is forced to a logic high state when the voltage on terminal C2b of capacitor C2 exceeds 500 mV. Clamp circuit 350 activates when the voltage on its terminal 350a reaches the clamp voltage configured for the clamp circuit. In one example, the clamp voltage is 5V and, accordingly, the voltage on terminal 332a of comparator increases sinusoidally from 0V to 5V and then is clamped at 5V for the remainder of the positive half-cycle until the voltage on terminal 350a falls below 5V.

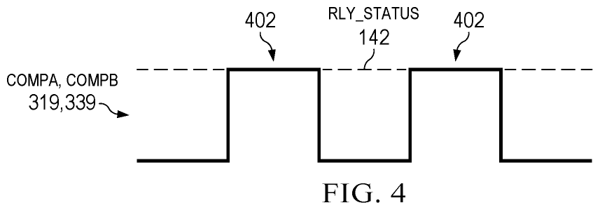

FIG. 4 is a timing diagram showing an example signal COMPB 339 from comparator 332 when relay 322 is closed. The positive pulses 402 of signal COMPB 339 coincide with the positive half-cycles of the sinusoidal line voltage and occur at the frequency of the line voltage (e.g., 50 Hz, 60 Hz). During each pulse 402, diode D2 turns on and provides a signal to the input terminal 360a of peak detector 360 that also has positive pulses like those shown in FIG. 4 but at one diode voltage drop (e.g., 0.7V) below the level of pulses 402 of the signal COMPB 339. If relay 302 is open, the output signal COMPA 319 of comparator 312 remains logic low and diode D1 does not turn on. Peak detector 360 receives the pulse pattern and generates signal RLY_STATUS 142 at a voltage level equal to the voltage of pulses 402 less the voltage drop of diode D1.

The voltage of the grid neutral (PE) is approximately the same as the ground coupled to terminal 340b of clamp circuit 340. Accordingly, comparator 312 does not trip logic high if relay 302 is closed. Instead, if both relay 302 is closed and the grid neutral experiences a short to a higher voltage, then comparator 312 will trip logic. The behavior of signal COMPA 319 in this condition is the same as COMPB 339 as shown in FIG. 4. When COMPA 319 is logic high, diode D1 turns on, and peak detector 360 outputs the signal RLY_STATUS 319 at a level that is equal to the voltage the positive pulses 402 of COMPA 319 less the voltage drop of diode D1.

Accordingly, relay status monitor circuit 110 in the example of FIG. 3 can detect either of two conditions (a) relay 322 is closed or (b) relay 302 is closed and Neutral is shorted to a higher voltage. Relay status monitor circuit 110 in FIG. 3 does not detect whether relay 302 is closed and no fault has occurred on the Neutral voltage itself. Further, relay status monitor circuit 110 in FIG. 3 and the other example relay status monitor circuits 110 described herein includes a capacitor to AC-couple a terminal of a relay to the corresponding clamp circuit and comparator thereby advantageously providing an isolated system.

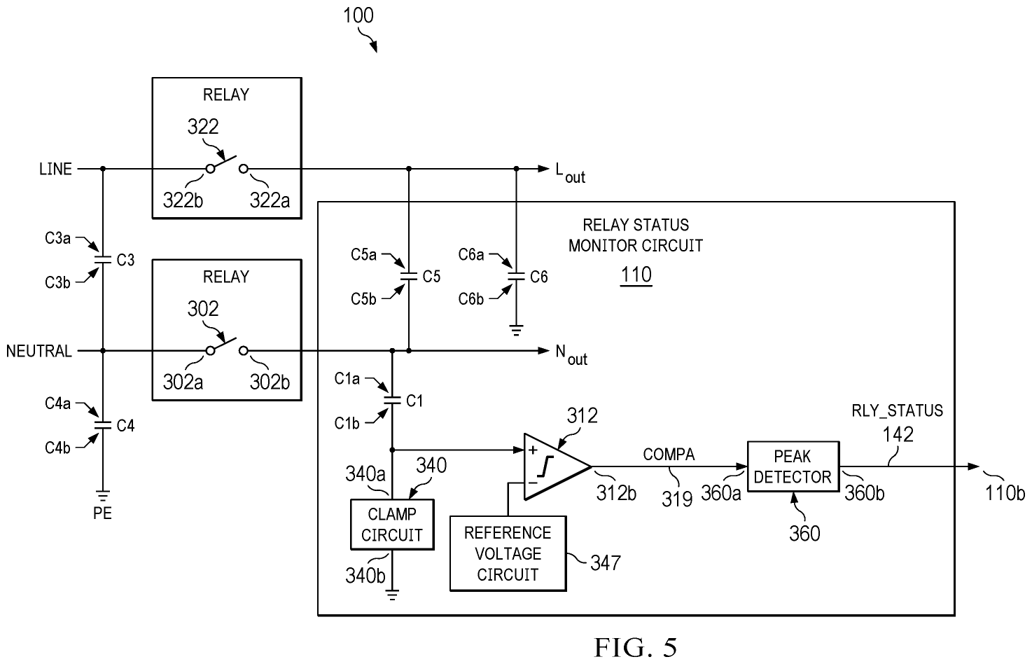

FIG. 5 is a schematic diagram of relay status monitor circuit 110 coupled to relays 302 and 322, in another example. The example of FIG. 5 is also of a single-phase AC charger. Relay status monitor circuit 110 of FIG. 5 includes capacitors C1, C3, and C4, comparator 312, clamp circuit 340, reference voltage circuit 347, and peak detector 360. Relay status monitor circuit 110 also includes capacitors C5 and C6. A terminal of capacitor C5 is coupled to terminal 322a of relay 322, and the other terminal of capacitor C5 is coupled to terminal 302b of relay 302. A terminal of capacitor C6 is coupled to terminal 322a of relay 322, and the other terminal of capacitor C6 is coupled to ground. The configuration of relay status monitor circuit 110 in FIG. 5 uses one clamp circuit 340 and one comparator 312 instead of a second pair of clamp circuit 350 and comparator 332 as in the example of FIG. 3. The relay status monitor circuit 110 of FIG. 5 also may not logic circuit A 118. Accordingly, relay status monitor circuit 110 of FIG. 5 may advantageously include fewer components than the relay status monitor circuit of FIG. 3.

When both relays 322 and 302 are open, the voltage on the positive terminal of comparator 312 is close to 0V and the comparator's output signal COMPA is logic 0. Accordingly, signal RLY_STATUS 142 will also be at a logic low level indicating that both relays are open.

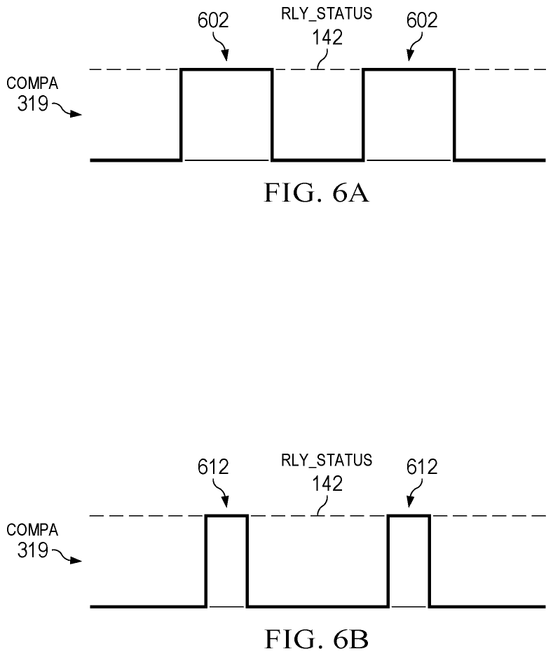

FIG. 6a are example waveforms for signals COMPA 319 and RLY_STATUS 142 when relay 322 is closed. Referring to FIGS. 5 and 6a, if relay 322 is closed, through the series coupling of capacitors C1 and C5, during each positive half-cycle of the Line voltage, the voltage on the comparator's positive terminal will be forced high enough for comparator 312 to force signal RLY_STATUS 142 to a logic high level forming positive pulses 602. Clamp circuit 340 clamps the voltage on the comparator's positive terminal as described above.

FIG. 6b are example waveforms for signals COMPA 319 and RLY_STATUS 142 when relay 302 is closed and the Neutral voltage is faulted to a level above 0V (e.g. shorted to Line). Referring to FIGS. 5 and 6b, if relay 302 is closed and the Neutral voltage is faulted to a level above 0V, comparator 312 also trips high during each positive half-cycle as indicated by the positive pulses 612. The width of the positive pulses 612 in FIG. 6b may be narrower than positive pulses 602 in FIG. 6a as a result of the duty cycle of the signal to the input of comparator 312 being different when both Line and Neutral relays 322 and 302 are closed than when just relay 322 is closed. From the difference in duty cycle of signal COMPA 319 between FIGS. 6A and 6B, the type of relay closed condition can be deduced (both relays closed versus only relay 322 being closed)

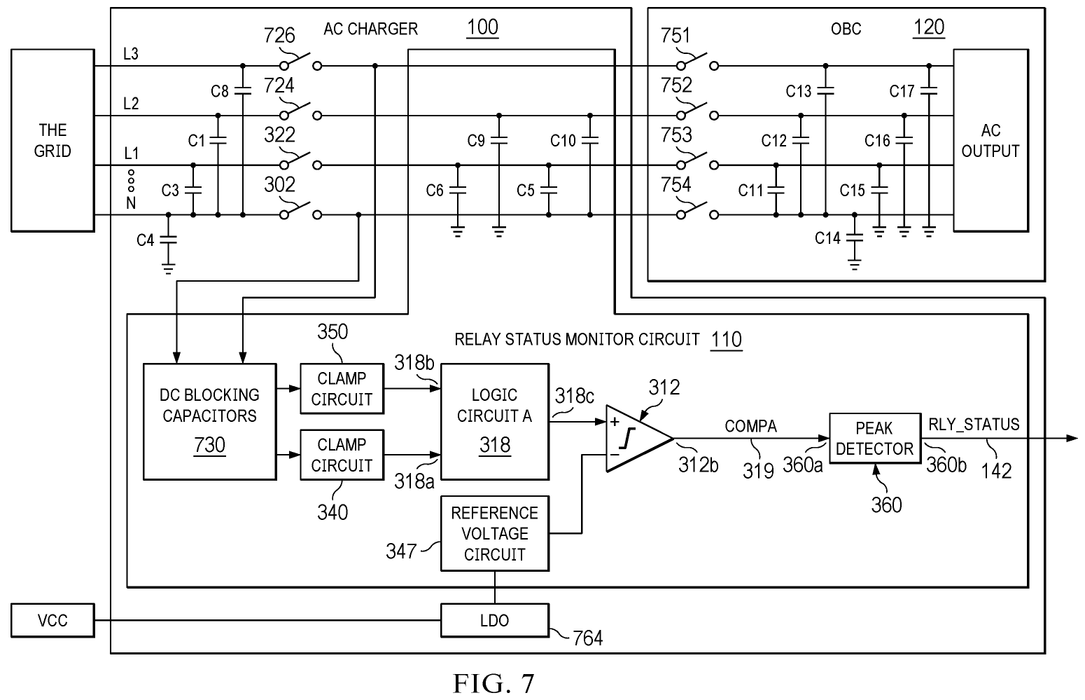

FIG. 7 is a block diagram of AC charger 100 that is a multi-phase charger including a relay status monitor circuit 110. AC charger 100 in FIG. 7 includes a relay for each line L1, L2, and L3, and neutral. The relays include relays 302 and 322, described above, and relays 724 and 726. Relay 302 is for Neutral. Relay 322 is for L1. Relay 724 is for L2. Relay 726 is for L3. AC charger 100 includes capacitors C3, C4, C5, C6, C7, C8, C9, and C10. Capacitors C3, C4, C7, and C8 are coupled between the respective lines (L1, L2, L3) and Neutral and ground.

AC charger 100 in FIG. 7 can be connected to an OBC 120 of a vehicle. In this example, OBC 120 includes switches 751, 752, 753, and 754 that couple to the respective relay 726, 724, 322, and 302 of AC charger 100. Switches 751-754 make or break electrical connectivity to the charger. OBC 120 also includes capacitors C11, C12, C13 coupled between the respective line (L1, L2, L3) and Neutral. OBC 120 also includes capacitors C14, C15, C16 and C17 coupled between ground and the respective line and Neutral on the grid side of relays 302, 322, 724, and 726. Capacitors C6 and C9 are coupled between the respective L1/L2 and ground on the OBC side of relays 302, 322, 724, and 726. Capacitors C5 and C10 are coupled between the respective L1/L2 and Neutral on the OBC side of the relays.

Relay status monitor circuit 110 in FIG. 7 includes DC blocking capacitors 730, clamp circuits 340 and 350, logic circuit A 318, reference voltage circuit 347, comparator 312, and peak detector 360. DC blocking capacitors 730 includes capacitor C1, coupled between Neutral and clamp circuit 340, as described above. DC blocking capacitors 730 may also include a capacitor coupled between L3 and clamp circuit 350. Logic circuit A 318 combines together (e.g., ORs together via diodes) the clamped Neutral and L3 voltages. The terminal 318c of logic circuit A 318 is coupled to the positive terminal of comparator 312. The negative input of comparator 312 is coupled to the reference voltage circuit 347, as described above. A voltage regulator (e.g., a low-drop out (LDO) voltage regulator 764 provides a regulated voltage based on supply voltage VCC to the reference voltage circuit 347 so that the reference voltage circuit 347 can generate an appropriate reference voltage to the negative input of comparator 312. Output terminal 312b of comparator 312 is coupled to the input terminal 360a of peak detector 360. Peak detector 360 generates the signal RLY_STATUS 142 at its output terminal 360b.

The operation of relay status monitor circuit 110 in FIG. 7 to detect that relay 322 (for L1) is closed is largely the same as that described above with regard to relay status monitor circuit 110 in FIG. 5. When relay 724 (for L2) is closed, capacitors C10 and C1 (within DC blocking capacitors 730) provide capacitive coupling between relay 724 and terminal 318a of logic circuit A 318, as clamped by clamp circuit 340. Accordingly, the voltage at the positive terminal of comparator 312 will be greater than the reference voltage from reference voltage circuit 347 during each half-cycle of the L2 voltage, and signal COMPA 319 will have a positive pulse during each half-cycle of the L2 voltage.

A capacitor within DC blocking capacitors 730 provides capacitive coupling between L3 and terminal 318b of clamp circuit, as clamped by clamp circuit 350. When relay 726 (for L3) is closed, the capacitive coupling between L3 and terminal 318b causes the voltage at terminal 318b to increase during each half-cycle until clamp circuit 350 is activated. Accordingly, the voltage at the positive terminal of comparator 312 will also be larger than the reference voltage during each positive half-cycle of L3, and comparator 312 will generate signal COMPA 319 to have a positive pulse, as described above.

Peak detector 360 tracks the peaks of signal COMPA 319 and generates a continuous logic high signal as signal RLY_STATUS 142 when any of relays 322, 724, and 726 are closed. The operation of relay status monitor circuit 110 when relay 302 is closed and Neutral faults to a larger voltage (e.g., shorts to L1, L2, or L3) is the same as described above.

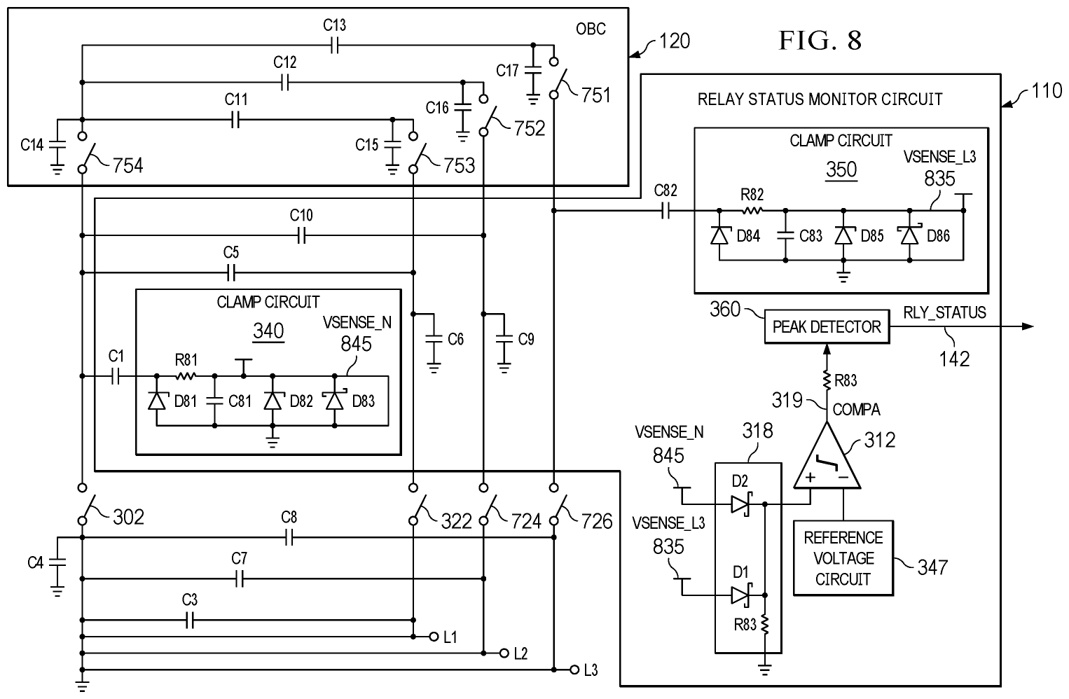

FIG. 8 is a schematic diagram of relay status monitor circuit 110 of FIG. 7 including examples of clamp circuits 340 and 350. Clamp circuit 340 includes diodes D81, D82, and D83, resistor R81, and capacitor C81. Diodes D81, D82, and D83 are transient voltage suppression, Zener, and Schottky diodes, respectively. A terminal of resistor R81 and the cathode of diode D81 are coupled to a terminal of capacitor C1. The anodes of diodes D81, D82, and D83 are coupled together and to a terminal of capacitor C81. The cathodes of diodes D82 and D83 are coupled to terminals of resistor R81 and capacitor C81. The signal at the cathodes of diodes D82 and D83 is signal VSENSE_N 845. The function of diodes D82 and D83 is to clamp the voltage range of signal VSENSE_N 845 to a safe working level (for both positive and negative voltages) for the low-voltage sensing circuit including comparator 312.

Clamp circuit 350 is similarly configured. Clamp 350 includes diodes D84, D85, and D86, resistor R82, and capacitor C83. Diodes D84, D85, and D86 are transient voltage suppression, Zener, and Schottky diodes, respectively. A terminal of resistor R82 and the cathode of diode D84 are coupled to a terminal of capacitor C82, whose other terminal is coupled to a terminal of relay 726 (for L3). The anodes of diodes D84, D85, and D86 are coupled together and to a terminal of capacitor C84. The cathodes of diodes D85 and D86 are coupled to terminals of resistor R82 and capacitor C83. The function of diodes D85 and D86 is to clamp the voltage range of signal VSENSE_L2 835 to a safe working level (for both positive and negative voltages) for the low-voltage sensing circuit including comparator 312.

Logic circuit A 318 includes diodes D1 and D2, as described above, and a resistor R83. The anode of diode D2 is coupled to the cathodes of diodes D82 and D83 and, accordingly, receives signal VSENSE_N 845. The anode of diode D1 is coupled to the cathodes of diodes D825 and D86 and, accordingly, receives signal VSENSE_L3 835. The signal VCOMPIN 825 is the signal at the cathodes of diodes D1 and D2 and the positive input of comparator 312. When either or both of signals VSENSE_L3 835 or VSENSE_N 845 are larger than the turn-on voltage (e.g., 0.7V) of diodes D1 and D2 than the voltage on their cathodes, the respective diode D1 and/or D2 turns on thereby forcing signal VCOMPIN 825 to a high enough voltage to cause comparator 312 to trip high and causing signal COMPA 319 to be at a logic high state. Otherwise, if neither VSENSE_L3 835 nor VSENSE_N 845 is larger than the turn-on voltage of diodes D1 and D2, then signal VCOMPIN 825 is pulled towards ground through resistor R83, and signal COMPA 319 is at a logic low state.

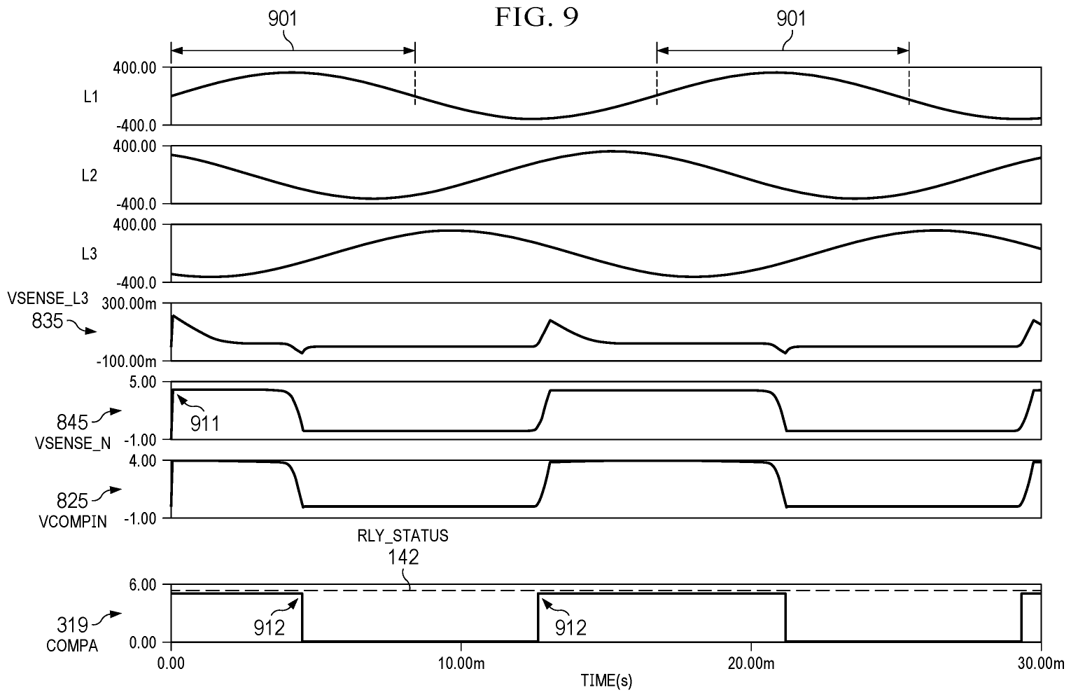

FIG. 9 includes waveforms illustrating the operation of relay status monitor circuit 110 in FIG. 8 when relay 322 (for L1) is closed. Relay 322 may be closed either due to the relay being welded closed or due to the relay being intentionally closed to charge the batteries of a vehicle. The signals in FIG. 9 include L1, L2, L3, VSENSE_L3 835, VSENSE_N 845, VCOMPIN 825, COMPA 319, and RLY_STATUS 142. As described above, L1, L2, and L3 are the voltage waveforms of each of the respective phases of the three-phase grid system, and, as shown, are 120 degrees out-of-phase with respect to each other.

Referring to FIGS. 8 and 9, during each positive half-cycle 901 of L1, signal VSENSE_N is clamped at a voltage of about 4.1V as indicated by reference numeral 911. In response to signal VSENSE_N 845 being at a voltage level of approximately 4.1V, diode D2 turns on, and comparator 312 forces its output signal COMPA 319 to a logic high state as shown at 912. Peak detector 360 generates signal RLY_STATUS 142 at a voltage level that is approximately equal to the voltage of the positive pulses of signal COMPA 319 (e.g., 4.1V in the example of FIG. 9).

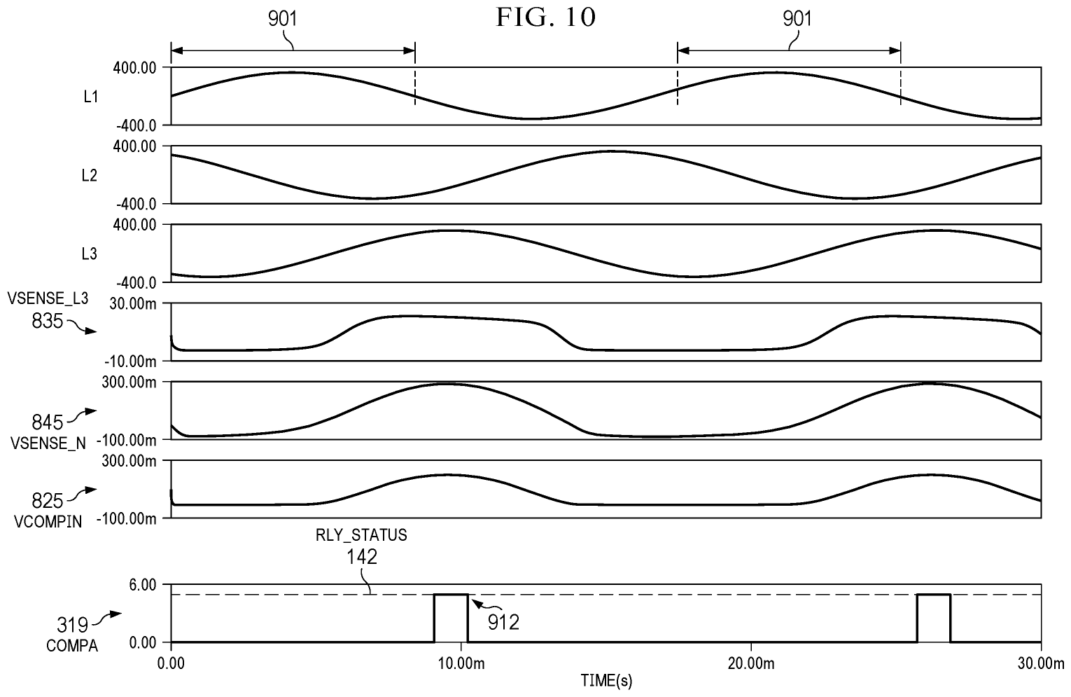

FIG. 10 includes waveforms illustrating the operation of relay status monitor circuit 110 in FIG. 8 when relays 302 (for Neutral) and 322 (for L1) both are closed and AC charger 100 is not coupled to the vehicle's OBC 120. Referring to FIGS. 8 and 10, during each positive half-cycle 901 of L1, current flows through relay 322, capacitor C5, relay 302 to ground, and back to relay 322 from L1. Capacitor C6 also conducts current to ground and such current then flows from ground through diode D82 thereby turning on diode D82 and clamping the voltage of signal VSENSE_N 845 to a high enough voltage to cause comparator 312 to trip signal COMPA 319 to a logic high state. Peak detector 360 generates signal RLY_STATUS 142 at a voltage level that is approximately equal to the voltage of the positive pulses of signal COMPA 319 in FIG. 10.

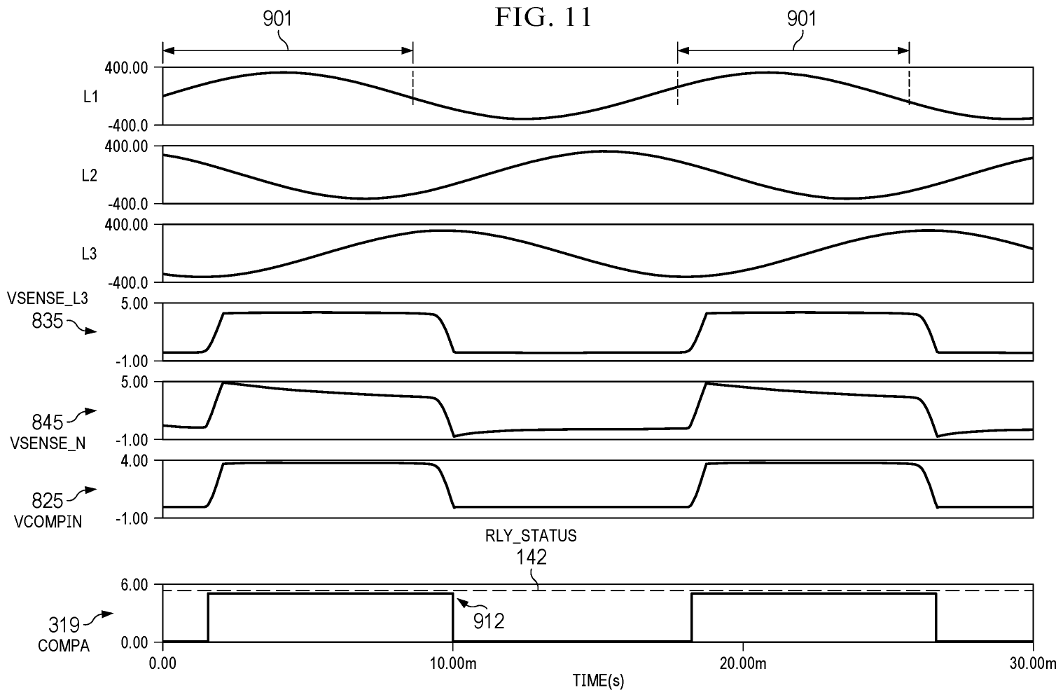

FIG. 11 includes waveforms illustrating the operation of relay status monitor circuit 110 in FIG. 8 when all of relays 302, 322, 724, and 726 are closed and AC charger 100 is coupled to the vehicle's OBC 120. Referring to FIGS. 8 and 11, because OBC 120 is coupled to AC charger 100 and the OBC's capacitors C15, C16, and C17 are effectively in parallel with capacitors C6 and C9 of relay circuit 110, the OBC's capacitors C15, C16, and C18 will dominate capacitors C6 and C9 of relay status monitor circuit 110 because the capacitance of capacitors C15-C17 may be significantly larger than the capacitance of capacitors C6 and C9. In one example the capacitance of each of capacitors C15-C17 is 15.6 nano-farads, and the capacitance of capacitors C6 and C9 is 220 pico-farads. The capacitance of the OBC's capacitors C11-C13 is larger than the capacitance of capacitors C5 and C10. In one example, the capacitance of capacitors C11-C13 is 5 micro-farads, and the capacitance of capacitors C5 and C10 is 1 nano-farad. Because capacitors C11-C13 are in parallel with capacitors C5 and C10, the capacitance of capacitors C11-C13 dominates the capacitance of capacitors C5 and C10.

With relays 302, 322, 724, and 726 closed and with the vehicle's relays 751-754 closed, current flows through capacitors C15-C17 to ground. Because the capacitances of capacitors C15-C17 are approximately the same, their common point (ground) is approximately 0V in a balanced three-phase system. A conduction pathway flows through capacitors C11-C13 to Neutral. Because the Neutral relay, relay 302, is closed, the voltage at the terminals of relay 302 is approximately 0V and, accordingly, signal VSENSE_N 845 remains at approximately 0V. Advantageously, however, clamp circuit 350 activates forcing signal VSENSE_L3 835 to a high enough voltage level in response to line voltage L3 being at a high enough level thereby causing comparator 312 to force signal COMPA 319 to logic high state.

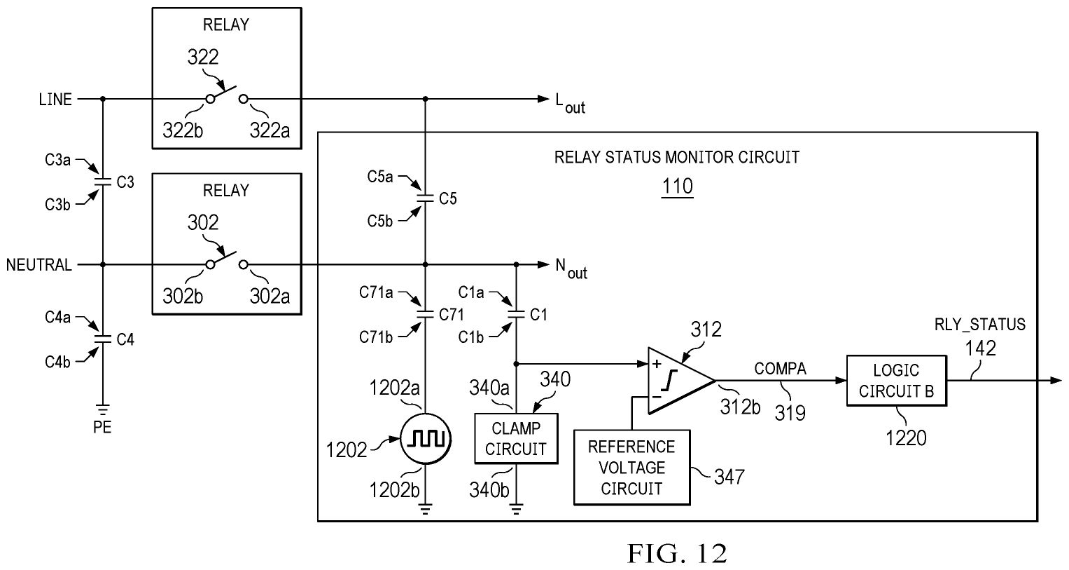

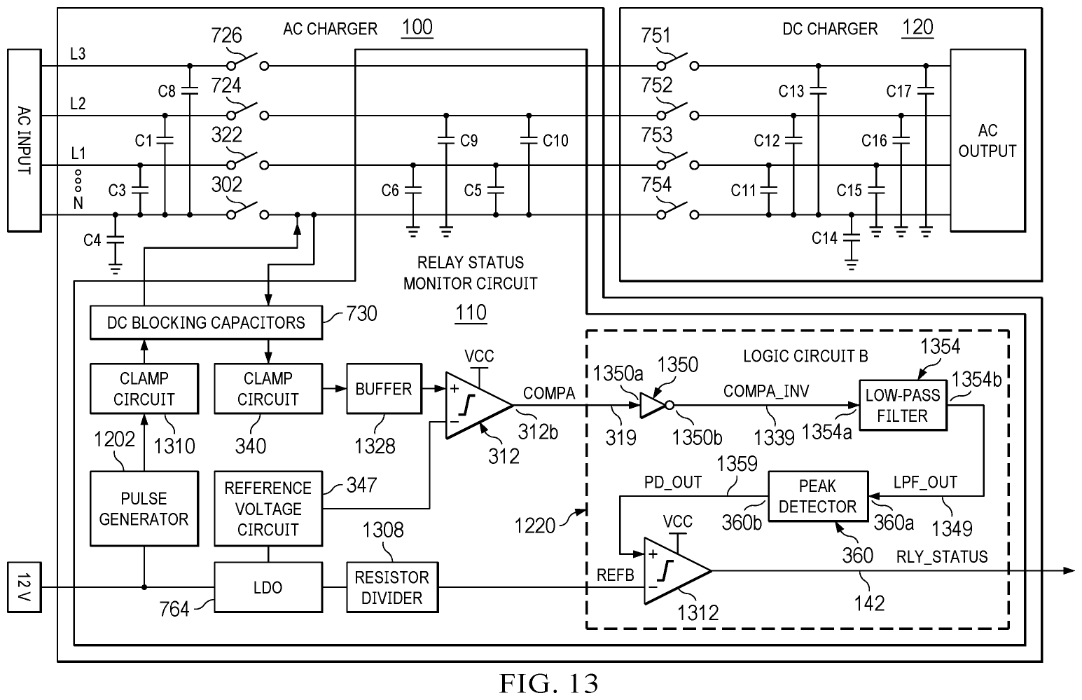

As explained above, the examples described in FIGS. 3-11 can detect a closure of relay 302 for Neutral if the Neutral itself is faulted to a higher voltage than 0V. FIG. 12 is a block diagram of a relay status monitor circuit 110 that includes a pulse generator usable by the relay status monitor circuit 110 to detect a closure of relay 302 even if Neutral is approximately 0V. The configuration of relay status monitor circuit 110 of FIG. 12 is similar to that of the relay status monitor circuit of FIG. 5. A difference in FIG. 12 is that relay status monitor circuit 110 includes a pulse generator 1202 and capacitor C71. Capacitor C71 and Relay status monitor circuit 110 in FIG. 12 also includes a logic circuit B 1220. pulse generator 1202 are coupled in series. A terminal C71a of capacitor C71 is couple to terminal 302a of relay 302 and terminal C5b of capacitor C5. Terminal C71b of capacitor C71 is coupled to a terminal 1202a of pulse generator 1202. Terminal 1202b of pulse generator 1202 is coupled to ground. Pulse generator 1202 generates a signal having a pulse train which is capacitively coupled to the positive input of comparator 312 through capacitors C71 and C1. The frequency of the pulse train generated by pulse generator 1202 is substantially higher than the frequency of the grid power. In one example, the frequency of the pulse train generated by pulse generator 1202 is in the range of 2 KHz to 5 KHz.

If neither relay 302 nor 322 is closed, then the signal at the positive input of comparator 312 is a time-varying signal whose frequency is the same as that of pulse train generated by pulse generator 1202. If relay 302 (for Neutral) is closed, then the signal at the positive input of comparator 312 is approximately 0V. If relay 322 is closed, then the signal at the positive input of comparator 312 is the sum of the Line voltage and the pulse train generated by pulse generator 1202. Accordingly, the signal at the positive input of comparator 312 is different for each of the aforementioned three conditions. Logic circuit B 1220 processes the signal COMPA signal 319 to determine whether neither of the relays are closed or whether one or both of the relays are closed and generates the signal RLY_STATUS 142 to be, for example, a logic high if either relay 302 or 322 is closed and a logic low if neither relay is closed. An example of logic circuit B 1220 is shown in FIG. 13 and described below.

FIG. 13 is a block diagram of a three-phase AC charger 100 whose relay status monitor circuit 110 includes, among other components, pulse generator 1202 and logic circuit B 1220. AC charger 100 in FIG. 13 includes relays 302, 322, 724, and 726, as described above. Relay status 110 includes DC blocking capacitors 730, clamp circuits 340 and 1310, buffer 1328, comparator 312, resistor divider 1308, LDO voltage regulator 764, and reference voltage circuit 347. DC blocking capacitors 730 include capacitor C1 coupled between Neutral and clamp circuit 340, as described above. Clamp circuit 340 is coupled to an input of buffer 1328. Buffer 1328 provides a high input impedance to clamp circuit 340 and is coupled to the positive terminal of comparator 312. Reference voltage circuit 347 uses a voltage from LDO voltage regulator 764 to generate the reference voltage to the negative terminal of comparator 312. An output of pulse generator 502 is coupled to clamp circuit 1310, and clamp circuit 1310 is coupled to Neutral through capacitor C71 within DC blocking capacitors 730. Both the LDO voltage regulator 764 and pulse generator 1202 receive power (e.g., 12V) from DC power supplied to AC charger 100.

Logic circuit B 1220 includes an inverter 1350, a low-pass filter 1354, peak detector 360, and a comparator 1312. The output terminal 312b of comparator 312 is coupled to the input terminal 1350a of inverter 1350, and the output terminal 1350b of the inverter is coupled to the input terminal 1354a of low-pass filter 1354. The output signal from inverter 1350 is COMPA_INV 1339. The output terminal 1354b of low-pass filter 1354 is coupled to the input terminal 360a of peak detector 360. The output signal from low-pass filter 1354 is LPF_OUT 1349. The output terminal 360b of peak detector 360 is coupled to the positive terminal of comparator 1312. The output signal from peak detector 360 is PD_OUT 1359. Resistor divider 1308 divides down the voltage from LDO voltage regulator 764 to provide an appropriate reference voltage, REFB, for comparator 1312. Comparator 1312 generates the signal RLY_STATUS 142 in this example.

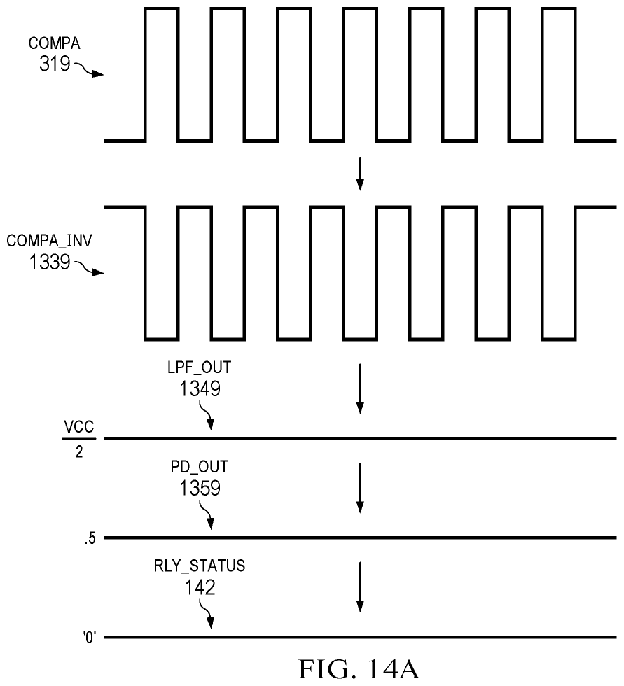

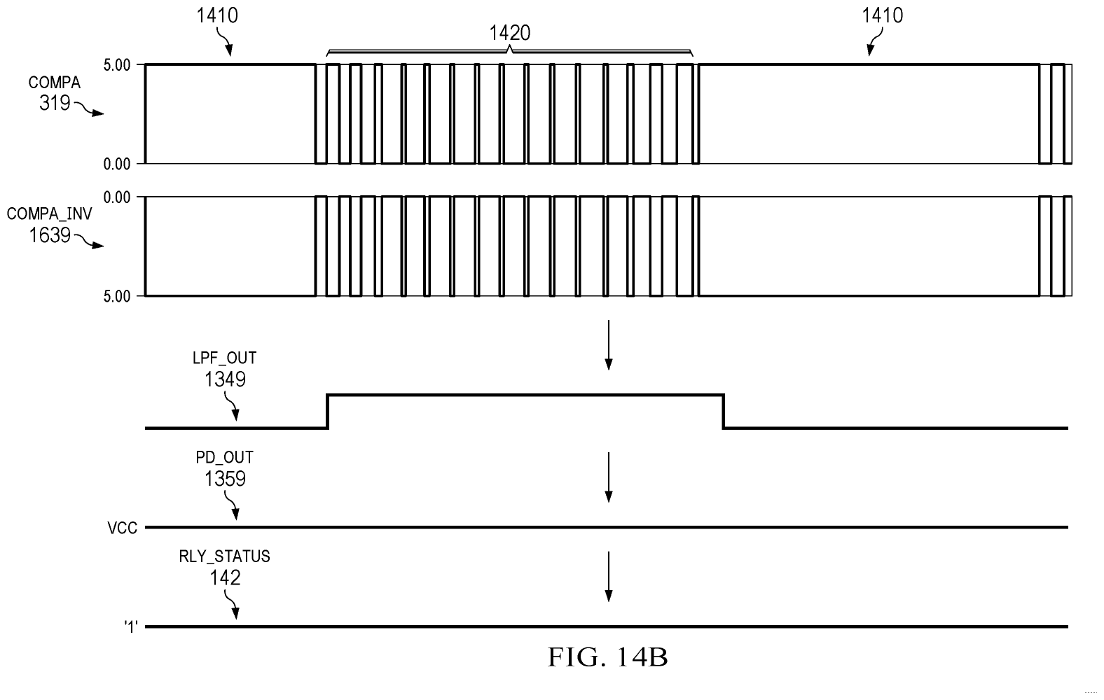

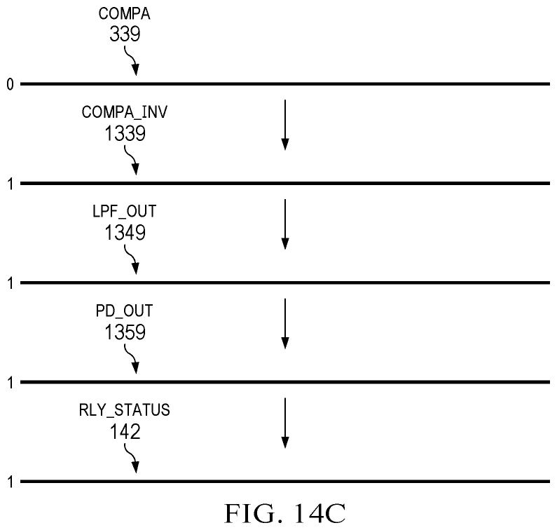

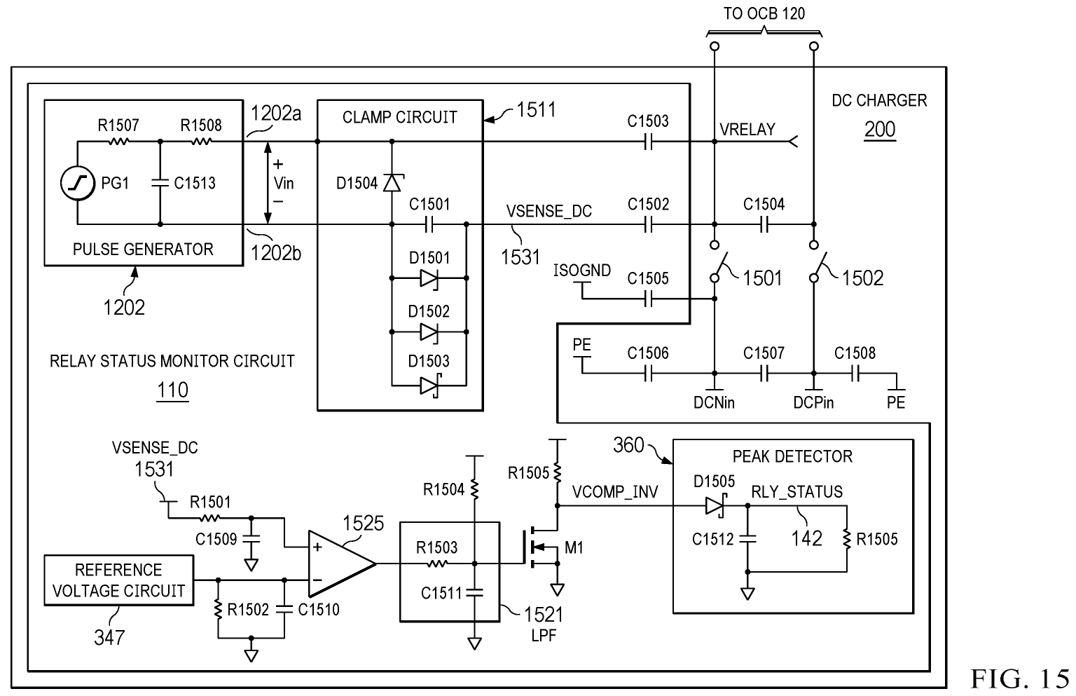

FIGS. 14A, 14B, and 14C include waveforms describing the operation of logic circuit B 1220 for different conditions. FIG. 14A describes the logic circuit B operation when none of the relays 302, 322, 724, or 726 are closed. FIG. 14B describes the logic circuit B operation when relay 322 (for L1) is closed. FIG. 14C describes the logic circuit B operation when relay 302 (for Neutral) is closed. Each of FIGS. 14A, 14B, and 14C includes signals COMPA 319, COMPA_INV 1639, LPF_OUT 1349, PD_OUT 1659, and RLY_STATUS 142.

Referring to FIGS. 13 and 14A (none of the relays are closed), the positive input of comparator 312 receives the pulse train signal from pulse generator 1202 and produces signal COMPA 319 to be a square wave at the same frequency as the signal generated by pulse generator 1202. Inverter 1350 inverts the logical state of signal COMPA 319. Low-pass filter 1354 has a 3 dB corner frequency between the grid frequency and the frequency of the pulse train generated by pulse generator 1202. In one example, the grid frequency is 50 Hz or 60 Hz and the pulse train has a frequency between 2 KHz and 5 KHz, and the corner frequency of low-pass filter 1354 is between those frequencies. The corner frequency may be, for example, 100 Hz. Low-pass filter 1354 is operative to pass the DC component of signal COMPA_INV 1339 while attenuating the higher frequency (e.g., 2-5 KHz) component. Accordingly, signal LPF_OUT 1349 is at a voltage that is approximately equal to the average of COMPA_INV 1349, which is one-half of the supply voltage (VCC) to low-pass filter 1354. Signal PD_OUT 1359 also is one-half of the supply voltage (VCC).

In this example, the reference voltage, REFB, to comparator 1312 is set to a level between VCC/2 and VCC. In a particular example, REFB is set to

$$\frac{3 * V CC}{4} .$$

### With REFB set to

$$\frac{3 * V CC}{4}$$

and signal PD_OUT 1359 equal to one-half of the supply voltage (VCC), comparator 1312 generates RLY_STATUS 142 to be a logic 0 thereby indicating that none of the relays are closed.

Referring to FIGS. 13 and 14B (a line relay is closed), comparator 312 produces signal COMPA 319 to be a clamped voltage 1410 during each positive half-cycle of the line voltage whose relay is closed. During each negative half-cycle, comparator 312 causes signal COMPA 319 to have the high frequency signal 1420 corresponding to the pulse train from pulse generator 1202. Inverter 1350 inverts signal COMPA 319 as shown as signal COMPA_INV 1639 in FIG. 14B. Signal COMPA_INV 1339 has both a 50 Hz or 60 Hz low-frequency component and a high frequency component (2-5 KHz). Following low-pass filter 1354 low-pass filtering signal COMPA_INV 1349, signal LPF_OUT 1349 attenuates the high-frequency component while passing the low-frequency component. Accordingly, signal LPF_OUT 1349 is a square wave having a frequency equal to the frequency of the grid (e.g., 50 Hz or 60 Hz) and whose peak voltages are VCC. Peak detector 360 generates signal PD_OUT 1359 at a voltage equal to positive peaks (VCC) of signal LPF_OUT 1359. Comparator 1312 generates RLY_STATUS 142 to be a logic 1 thereby indicating that a relay is closed, one of the line relays in this example.

Referring to FIGS. 13 and 14C, relay 302 for Neutral is closed, and the signal at the positive terminal of comparator 312 is approximately 0V. Accordingly, comparator 312 forces signal CMPA 339 to a logic low level. Inverter 1350 inverts the logic low to a logic high for signal COMPA_INV 1339. Low-pass filter 1354 generates signal LPF_OUT 1349 to be a logic high as well. Peak detector 360 generates PD_OUT 1359 as a logic high. Comparator 1312 generates RLY_STATUS 142 to be a logic 1 thereby indicating that a relay is closed, relay 302 in this example.

FIG. 15 is a schematic diagram of DC charger 200, in an example. DC charger 200 includes relays 1501 and 1502, capacitors C1504, C1506, C1507, and C1508, and a relay status monitor circuit 110. Relay 1501 provides the negative DC voltage, DCNin to the OBC 120 of the vehicle. Relay 1502 provides the positive DC voltage, DCPin to the OBC 120. Relay status monitor circuit 110 includes pulse generator 1202, comparator 1525, diodes D1501, D1502, D1503, D1504, and D1505, capacitors C1501, C1502, C1503, C1505, C1509, C1510, C1511, and C1512, resistors R1501, R1502, R1503, R1504, R1505, and R1506, and transistor M1. Pulse generator 1202 includes resistors R1507 and R1508, capacitor 1513 and a signal generator PG1 (PG1 refers both to the signal generator and the signal produced therefrom). Diodes D1501-D1504 and capacitor C1501 are coupled together to form a clamp circuit 1511. Resistor R1503 and capacitor C1511 are coupled together to form a low-pass filter 1521. Diode D1505, capacitor C1512, and resistor R1505 are coupled together to form peak detector 360.

In this example, resistor R1507 is coupled to capacitor C1513 to form a low-pass filter, whose corner frequency is greater than the frequency of pulse generator. The low-pass filter formed by the combination of resistor R1507 and capacitor C1513 functions to filter out higher frequency content (e.g., electromagnetic interference). Voltage Vin is the output voltage from pulse generator 1202 and is provided across terminals 1202a and 1202b of the pulse generator,

Capacitor C1507 is coupled across one pair of terminals of relays 1501 and 1502, and capacitor C1504 is coupled across the other pair of terminals of relays 1501 and 1502. Capacitor C1506 is coupled between a terminal of capacitor C1507 and ground (e.g., earth ground). Similarly, C1508 is coupled between the other terminal of capacitor C1507 and ground (e.g., earth ground). Capacitor C1505 is coupled between capacitor C1507 and an isolated ground. Capacitor C1502 is coupled between a terminal of relay 1501 and the cathodes of diodes D1501-D1503. The signal (e.g., voltage) at the cathodes of diodes D1501-D1503 is signal VSENSE_DC 1531. Capacitor C1503 is coupled between the same terminal of relay 1501 and the cathode of diode D1504, which is coupled to terminal 1202a of pulse generator 1202. The anodes of diodes D1501-D1503 are coupled together and to a terminal 1202b of pulse generator 1202.

The cathodes of diodes D1501-D1503 are coupled to the positive input terminal of comparator 1525 through resistor R1501. Capacitor C1509 is coupled between the positive input terminal of comparator 1525 and ground. The output terminal of comparator 1525 is coupled to the input of low-pass filter 1521. Reference voltage circuit 347 has an output coupled to the negative input of comparator 1525. Resistor R1502 and capacitor C1510 are coupled in parallel between the negative input terminal of comparator 1525 and ground. Comparator 1525 compares the output signal from low-pass filter 1521 to a reference voltage (REF) from reference voltage circuit 347. The reference voltage is set at, for example, 500 mV.

Low-pass filter 1521 is configured to have a corner frequency between the grid frequency and the frequency of the pulse train generated by pulse generator 1202 (e.g., 100 Hz). The corner frequency of low-pass filter 1521 is configured by the resistance of resistor R1503 and the capacitance of capacitor C1511.

Transistor M1 is a field effect transistor (FET) in the example of FIG. 15. Resistor R1503 is coupled between the output terminal of comparator 1525 and the gate of transistor M1. Resistor R1504 is coupled between VCC and the gate of transistor M1 and a terminal of capacitor C1511. The other terminal of capacitor C1511 is coupled to ground. Resistor R1505 is coupled between the drain of transistor M1 and VCC, and the source of transistor M1 is coupled to ground. Transistor M1 is configured to logically invert the output signal from comparator 1525. If the output signal from comparator 1525 is logic high, transistor M1 is on, and the voltage at its drain to peak detector 360 is pulled low through transistor M1. By contrast if the output signal from comparator 1525 is logic low, transistor M1 is off, and the voltage at its drain is pulled high through resistor R1504.

Within peak detector 360, the anode of diode D1505 is coupled to the drain of transistor M1, and the cathode of diode D1505 is coupled to respective terminals of capacitor C1512 and resistor R1505. The other terminals of capacitor C1512 and resistor R1505 are coupled to ground. The voltage on the cathode of diode D1505 is the signal RLY_STATUS 142. When transistor M1 is off, diode D1505 turns on and current flows through resistor R1505 and transistor M1 to capacitor C1512. Capacitor C1512 begins to charge thereby forcing signal RLY_STATUS 142 to a higher voltage level. When transistor M1 is on, diode D1505 turns off and capacitor C1512 begins to discharge into resistor R1506 thereby forcing signal RLY_STATUS 142 to a lower voltage level. The voltage on the anode of diode D1505 is signal VCOMP_INV.

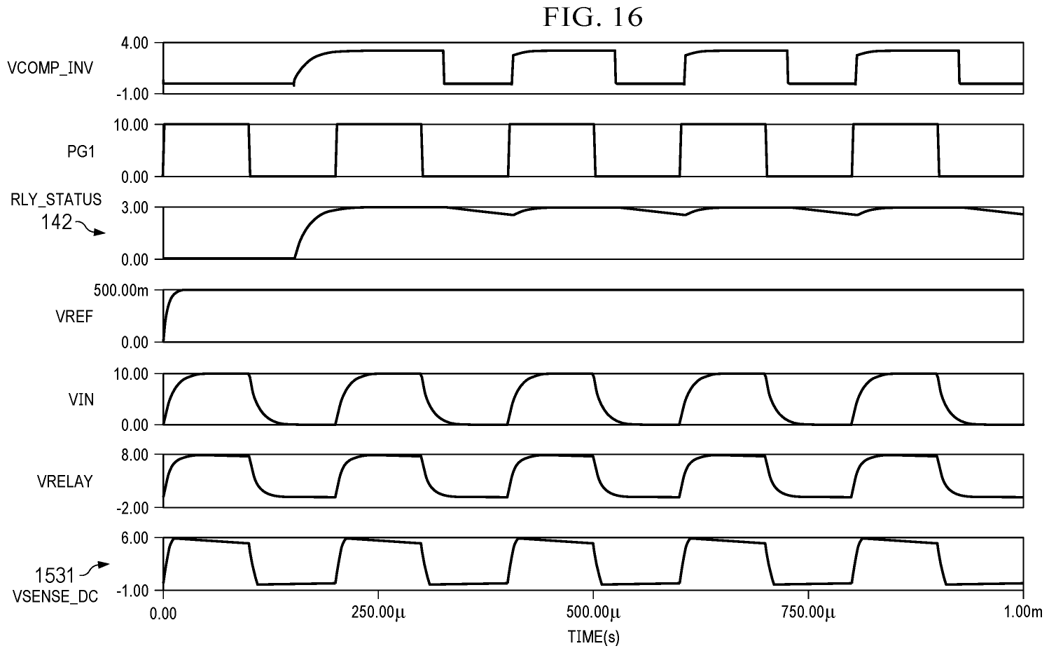

The operation of relay status monitor circuit 110 in FIG. 15 is similar to the operation of status circuit 110 in FIG. 12. FIG. 16 are waveforms illustrating the operation of relay status monitor circuit 110 of FIG. 15 when neither relay 1501 nor 1502 is closed. The signal VSENSE_DC 1531 is a square wave having a frequency equal to the frequency generated by pulse generator 1202. PG1 is the raw pulse generator signal before being filtered, and Vin is the low-pass filtered signal from pulse generator 1202. Because the effective load capacitance is lower when the relays are open, the signal VSENSE_DC 1531 is close to the maximum level allowed by diode D1501 (transient voltage suppression clamp diode). Signal VCOMP_INV has an inverted logic of Vin. The VCOMP_INV signal is logically inverted from signal Vin. Signal VCOMP_INV is provided to peak detector 360, which outputs signal RLY_STATUS 142. Logic high for signal RLY_STATUS 142 indicates that relays 1501 and 1502 are open.

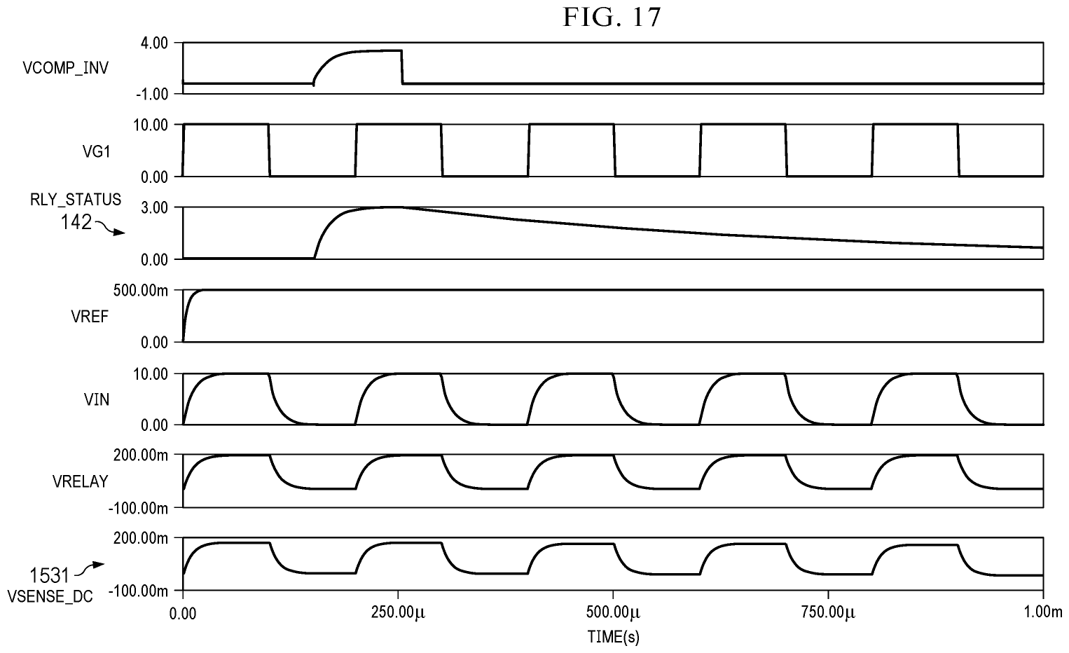

FIG. 17 are waveforms illustrating the operation of relay status monitor circuit 110 of FIG. 15 when either relay 1501 or 1502 is closed. Because the effective load capacitance is higher when either relay is closed, the magnitude of signal VSENSE_DC 1531 is lower (e.g. 200 mV in FIG. 17). The lower level for signal VSENSE_DC 1531 is not high enough to trip comparator 1525 so that signal RLY_STATUS 142 is 0V after the comparator settles. A low logic for signal VSENSE_DC 1531 indicates that a relay is closed in this example.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. A battery charger, comprising:
a relay having a first terminal and a second terminal;
a capacitor having a first terminal and a second terminal, the first terminal coupled to the second terminal of the relay;
a clamp circuit coupled to the second terminal of the capacitor;
a reference voltage circuit having an output terminal; and
a comparator having a first comparator input terminal coupled to the second terminal of the capacitor and having a second comparator input terminal coupled to the output terminal of the reference voltage circuit.

2. The battery charger of claim 1, wherein the comparator has an output terminal, and the battery charger further comprises a peak detector coupled to the output terminal of the comparator.

3. The battery charger of claim 1, wherein the relay is a first relay and the capacitor is a first capacitor, and the battery charger further comprises:
a second relay having a first terminal and a second terminal; and
a second capacitor coupled between the second terminal of the second relay and the second terminal of the first relay.

4. The battery charger of claim 3, further comprising a pulse generator coupled to the second terminal of the first relay.

5. The battery charger of claim 4, further comprising:
a third capacitor having first and second terminals, the first terminal of the third capacitor coupled to the second terminal of the first relay, and the second terminal of the third capacitor coupled to the pulse generator; and
a fourth capacitor coupled to the first terminal of the first relay.

6. The battery charger of claim 4, wherein the comparator is a first comparator, the first comparator having a first comparator output terminal, and the battery charger further comprises:
an inverter having an input terminal and an output terminal, the input terminal of the inverter coupled to the first comparator output terminal;
a filter having an input terminal and an output terminal, the input terminal of the filter coupled to the output terminal of the inverter;
a peak detector having an input terminal and an output terminal, the input terminal of the peak detector coupled to the output terminal of the filter; and
a second comparator having an input coupled to the output terminal of the peak detector.

7. The battery charger of claim 1, wherein the relay is a first relay, the capacitor is a first capacitor, the clamp circuit is a first clamp circuit, and the battery charger further comprises:
a second relay having a first terminal and a second terminal;
a second capacitor having a first terminal and a second terminal, the first terminal of the second capacitor coupled to the second terminal of the second relay; and
a second clamp circuit coupled to the second terminal of the second capacitor.

8. The battery charger of claim 7, further comprising a logic circuit having a first logic circuit terminal, a second logic circuit terminal, and a third logic circuit terminal, the first logic circuit terminal coupled to the second terminal of the first capacitor, the second logic circuit terminal coupled to the second terminal of the second capacitor, and the third logic circuit terminal coupled to the input terminal of the comparator.

9. The battery charger of claim 1, wherein the battery charger is an alternating current (AC) charger.

10. The battery charger of claim 1, wherein the battery charger is a direct current (DC) charger.

11. A circuit, comprising:
a capacitor having a first terminal and a second terminal;
a clamp circuit coupled to the second terminal of the capacitor;
a reference voltage circuit having an output terminal;
a comparator having a first input terminal coupled to the second terminal of the capacitor and having a second input terminal coupled to the output terminal of the reference voltage circuit, the comparator having an output terminal; and
a peak detector coupled to the output terminal of the comparator.

12. The circuit of claim 11, further comprising a pulse generator coupled to the first terminal of the capacitor.

13. The circuit of claim 12, wherein the capacitor is a first capacitor, and the circuit further comprises a second capacitor having first and second terminals, the first terminal of the second capacitor coupled to the first terminal of the first capacitor, and the second terminal of the second capacitor coupled to the pulse generator.

14. The circuit of claim 12, wherein the comparator is a first comparator, the peak detector has an input terminal and an output terminal, the first comparator having a first comparator output terminal, and the circuit further comprises:
an inverter having an input terminal and an output terminal, the input terminal of the inverter coupled to the first comparator output terminal;
a filter having an input terminal and an output terminal, the input terminal of the filter coupled to the output terminal of the inverter, and the output terminal of the filter coupled to the input terminal of the peak detector; and
a second comparator having an input coupled to the output terminal of the peak detector.

15. The circuit of claim 14, wherein the filter is a low-pass filter.

16. A battery charger, comprising:
a relay having a first terminal, a second terminal, and a control terminal;
a controller having an output terminal and an input terminal, the output terminal coupled to the control terminal; and
a relay status monitor circuit having a first terminal and a second terminal, the first terminal of the relay status monitor circuit coupled to the second terminal of the relay, the second terminal of the relay status monitor circuit coupled to the input terminal of the controller, the relay status monitor circuit including a capacitor coupled to the first terminal of the relay status monitor circuit, the relay status monitor circuit configured to determine a state of the relay and generate a signal at the second terminal of the relay status monitor circuit indicative of the state.

17. The battery charger of claim 16, wherein the relay status monitor circuit further comprises:
a clamp circuit coupled to the second terminal of the capacitor; and
a comparator having an input terminal coupled to the second terminal of the capacitor, the comparator having an output terminal.

18. The battery charger of claim 17, wherein the relay is a first relay and the capacitor is a first capacitor, the battery charger further includes:
a second relay having a first terminal and a second terminal; and
a second capacitor coupled between the second terminal of the second relay and the second terminal of the first relay.

19. The battery charger of claim 18, further comprising:
a pulse generator;
a third capacitor having first and second terminals, the first terminal of the third capacitor coupled to the second terminal of the first relay, and the second terminal of the third capacitor coupled to the pulse generator; and
a fourth capacitor coupled to the first terminal of the first relay.

20. The battery charger of claim 17, wherein the relay is a first relay, the capacitor is a first capacitor, the clamp circuit is a first clamp circuit, and the battery charger further comprises:
a second relay having a first terminal and a second terminal;
a second capacitor having a first terminal and a second terminal, the first terminal of the second capacitor coupled to the second terminal of the second relay; and
a second clamp circuit coupled to the second terminal of the second capacitor.
